(19) United States
(12) Patent Application Publication
(10) Pub. No.: US 2013/0226622 A1
(43) Pub. Date: Aug. 29, 2013

(54) Methods Using Speed Distribution Profiles

(71) Applicants: TOMTOM INTERNATIONAL B.V., (US); TOMTOM NORTH AMERICA INC., (US)

(72) Inventors: Anthony Adamson, Nijmegen (NL); Christopher Kenneth Hoover Wilson, Emerald Hills, CA (US)

(73) Assignees: TOMTOM NORTH AMERICA INC., Lebanon, NH (US); TOMTOM INTERNATIONAL B.V., Amsterdam (NL)

(21) Appl. No.: 13/762,415

(22) Filed: Feb. 8, 2013

Related U.S. Application Data
(60) Provisional application No. 61/596,508, filed on Feb. 8, 2012.

(30) Foreign Application Priority Data
Mar. 23, 2012 (GB) GB1205125.6

(51) Int. Cl. G06Q 40/08

(52) U.S. Cl. CPC G06Q 40/08
USPC 705/4

(57) ABSTRACT

A method is disclosed of providing driver behaviour based insurance comprising accessing a digital map having data indicative of a plurality of navigable segments, wherein the digital map further comprises data representative of a speed distribution profile for one or more positions along at least one of the navigable segments, the speed distribution profile for a position being indicative of the speed of multiple drivers at the position. The data representative of a speed distribution profile is used to set a recommended speed for vehicles travelling along the at least one navigable segment. The speed of a subscriber driver is monitored when travelling along the at least one navigable segment to obtain data regarding the speed of the driver relative to the recommended speed for at least one of the one or more positions, and the relative speed data is used as an input to a model of a user based insurance system.

### CROSS REFERENCE TO RELATED APPLICATIONS

This application claims the benefit of U.S. Provisional Patent Application No. 61/596,508 filed Feb. 8, 2012 and United Kingdom Patent Application No. 1205125.6 filed Mar. 23, 2012. The entire contents of both these applications is incorporated herein by reference.

### FIELD OF THE INVENTION

The present invention particularly, although not exclusively, relates to methods for providing a speed recommendation for a vehicle travelling around or approaching a curve, and to methods for providing a speed recommendation for a manoeuvre at a junction or intersection. The present invention also relates to an apparatus having position data obtaining capability and being arranged to carry out such methods, or at least parts of such methods. The invention also extends to methods of storing data in association with navigable segments or nodes of a digital map, and a database storing such data.

In embodiments, the invention may be implemented, at least in part, using an apparatus having position data determining capability, such as a navigation apparatus. Illustrative embodiments of the invention relate to portable navigation devices (so-called PNDs), in particular PNDs that include Global Positioning System (GPS) signal reception and processing functionality, and to systems and methods involving such devices. The invention is also applicable to a navigation apparatus which forms part of an integrated navigation system, e.g. an in-vehicle navigation system, and to systems and methods using such apparatus. The invention is also applicable to apparatus having position data determining capability, but which may not include route planning capability, for example including apparatus used in Advanced Driver Assistance Systems (ADAS).

### BACKGROUND OF THE INVENTION

One problem which drivers face is the selection of a suitable speed for travel around a curve. This can be particularly challenging when the road is not known to the driver, and the appropriate speed may vary along the length of the curve, e.g. as the form of the curve changes.

Numerous factors can affect the appropriate selection of a speed at any given point around the curve, including features of the road surface or configuration, the type of vehicle, and also factors which can vary over time, such as visibility, weather conditions, etc. In cases where an ADAS system is employed, the same problems exist in relation to determining a suitable speed in accordance with which to, for example, control the vehicle during travel around a curve. Similar problems exist in relation to selection of a suitable speed when performing a manoeuvre at a junction or intersection.

Previous techniques for determining a recommended speed for a vehicle travelling around a curve, whether to provide to a driver or to input to an ADAS system, have involved carrying out complex calculations based on the geometry of the curve. Typically the curve is considered to be made up of a number of small sections, each having a discrete curvature value assigned thereto. An appropriate speed is assigned to each section based on the curvature value of the section. The calculation may take into account other parameters, including, for example, parameters based on the road surface, category of road, type of vehicle, etc. One example of this type of method is described in US 2007/0150157 A1. Such methods involve complex and detailed calculations and modelling of the curve, and there are difficulties in determining a practical and safe speed recommendation for the real world using such theoretical techniques, e.g. in terms of accounting for relevant variables, etc. These types of method also may not provide any great flexibility in speed recommendation, being based on the geometry of the curve.

The Applicant has realised that there remains a need for improved methods for providing speed recommendations for travel around a curve, or when performing a manoeuvre at a junction or intersection.

### SUMMARY OF THE INVENTION

In accordance with a first aspect of the invention there is provided a method for providing a speed recommendation for a vehicle comprising:

accessing a digital map having data indicative of a plurality of navigable segments, the plurality of navigable segments including at least one navigable segment representative of a curve, and wherein the digital map further comprises data indicative of a plurality of positions along the navigable segment representative of a curve, each of the plurality of positions being associated with data representative of a respective speed distribution profile for the position, the speed distribution profile being indicative of the speed of multiple drivers at the position when travelling around the curve; and

using the data representative of a speed distribution profile to provide a speed recommendation for a vehicle approaching or travelling around the curve.

Thus, in accordance with the invention, data representative of a speed distribution profile indicative of the speed of multiple drivers at the position (which, for brevity, will be referred to as “speed distribution profile data” herein), is associated with each of a plurality of positions along a navigable segment of a digital map representing a curve. This speed distribution profile data is then used to provide a speed recommendation for a vehicle travelling around, or about to travel around, the curve. As discussed below, the speed recommendation may be a recommendation provided to a driver and/or a recommendation used to automatically control the speed of the vehicle, e.g. via an Advanced Driver Assistance System (ADAS) device. The speed distribution profile data is indicative of the speeds of multiple drivers at the position when travelling around the curve, i.e. historical speed distribution profile data. In this way, the speed recommendation is provided taking into account speed distribution profile data representative of the actual speeds at which different drivers have previously traveled around the curve. This is in contrast to prior art techniques as outlined above, which instead provided a speed recommendation determined in a theoretical calculation based upon the geometry of the curve.

In accordance with the invention, the speed recommendation takes into account the behaviour of actual drivers, and, furthermore, is indicative of the speeds at which multiple drivers have driven at a given position when travelling around the curve, rather than being for example a single averaged value. Thus the data includes information about multiple possible speeds for the given position. This provides the ability to provide more reliable speed recommendations, as well as greater flexibility and the opportunity to tailor recommendations to a given driver, based upon their driving style or preferences. For example, in some embodiments the speed distribution profile data may include upper and lower speed percentile data, to enable a recommendation to be provided relative to a desired percentile depending upon driver style or preferences. Higher speeds may be recommended to drivers who have expressed a preference for a more aggressive style, or who, on the basis of a driver profile, are known to drive in this manner, while more timid drivers may be recommended lower speeds. As the speed distribution profile data is based on the speeds of actual drivers at the relevant positions, there can be greater confidence that the recommendations are appropriate and safe, without the significant complexity of calculation and testing that would need to be carried out to provide a similar level of confidence using theoretical techniques. In particular, factors which might not be considered by a theoretical model, or which may prove difficult to quantify, such as visibility at particular points when traversing the curve, may be taken into account. The present invention also opens up the opportunity to provide recommendations specific to particular road conditions or times of day, using appropriate speed profiles.

As used herein by reference to the invention in any of its aspects or embodiments, the term “navigable segment” is understood in its usual sense as being a link or segment defined between two nodes of a navigable network. The navigable segment may typically be a road segment. However, it will be appreciated that the methods of the present invention are also applicable to other forms of navigable segments, such as “off-road” tracks which may be indicated by a digital map.

The method in accordance with the first aspect of the present invention is implemented using speed distribution profile data associated with a navigable segment of a digital map, which is representative of a curve. The navigable segment may be one of a set of navigable segments together representative of a curve, or may represent a curve alone. Thus the curve represented by the navigable segment with respect to which the methods of the present invention are carried out may form part of a longer curve represented by other navigable segments. However, preferably the navigable segment is representative of the entirety of the curve. For brevity, the methods of the invention will be described by reference to “a navigable segment representative of a curve”, although it will be appreciated that the methods may be carried out with respect to a plurality of, or each navigable segment of the digital map which is representative of a curve, i.e. with respect to any or all of the segments representative of a curve.

In accordance with the invention of the first aspect of the invention, the speed distribution profile data is associated with each of a plurality of positions defined along the navigable segment representative of a curve. Where multiple navigable segments together represent a given curve, the speed distribution profile data may be associated with each of a plurality of positions defined along a, some or preferably each of the navigable segments representing the curve. In other words, the data will be associated with at least one of the navigable segments representative of the curve. It is preferable that the speed distribution profile data is associated with each navigable segment as this may allow improved guidance to be provided throughout travel around the curve.

The navigable segment (or part thereof) which is representative of the curve may be a navigable segment represented by a curved line to indicate curvature, or may be associated with shape information indicative of curvature. The or each navigable segment may be associated with one or more shape points along its length describing the curvature, e.g. with each point having an associated radius of curvature.

The plurality of positions defined along the navigable segment representing the curve are positions defined along the navigable segment as indicated by a digital map. The positions correspond to real world physical positions along the navigable segment represented by the digital map. The positions may be at any desired interval along a navigable segment. The spacing may be chosen to enable suitably precise speed guidance to be provided around the curve. By way of example, the positions may be spaced at intervals of less than 200 m, less than 100 m, or preferably, less than 50 m or less than 20 m. The positions may be equally spaced. However, in other arrangements, the spacing of the positions may depend upon the degree of curvature of the navigable segment, or the distance from a particular point on the curve, etc. The positions are discrete positions or points. The positions are positions along the longitudinal direction of the navigable segment. The speed herein refers to an instantaneous speed at the relevant position.

It will be appreciated that the techniques of the present invention in which data representative of a speed distribution profile specific to the position is associated with each of a plurality of positions along at least one given navigable segment, i.e. along the same navigable segment, are in contrast with assigning data representing a speed distribution profile with a navigable segment as a whole. In such techniques, all positions along the length of the navigable segment would be associated with the same or a common speed profile. For example, in some prior art techniques, e.g. to enable prediction of travel times, etc, a single speed distribution profile representing an average speed may be associated with all positions along a given navigable segment. Instead, in accordance with the invention, different discrete positions, e.g. points along the same navigable segment are each associated with data representing a speed distribution profile specific to that position. The speed distribution profile for each given position is indicative of the speed traveled by multiple drivers travelling around the curve when at that position. There are as many speed distribution profiles as positions. The speed distribution profile for each position along the navigable segment may, and usually will be different, i.e. non identical.

In accordance with the first aspect of the invention, the speed distribution profile data is representative of the speed of multiple drivers travelling along the navigable segment when passing through the given position along the navigable segment. This is in contrast to data which represents a speed profile in the form of a single speed for a given position, such as an average or highest speed for the position obtained from data relating to the speeds of multiple drivers passing through the position, or a determined maximum or safe speed. In accordance with the present invention, the speed profile data instead is speed distribution profile data, and contains information about multiple possible speeds for travelling through the point when going around the curve. While the speeds indicated by the profile in accordance with the invention may be speeds derived from information collected about the speeds traveled by still more drivers, such that the plurality of speeds indicated by the speed distribution profile may be the result of some processing of raw data, e.g. averaging, binning etc, they are still indicative of a plurality of speeds taken by different drivers.

The present invention also extends to the use of speed distribution profile data for providing speed recommendations for a manoeuvre at a junction or intersection.

Thus, in accordance with a second aspect of the invention there is provided a method for providing a speed recommendation for a vehicle comprising:

accessing a digital map having data indicative of a plurality of navigable segments and nodes, wherein at least some of the nodes are indicative of a junction or intersection, and wherein the digital map further comprises data indicative of a plurality of speed distribution profiles associated with at least one node, each speed distribution profile being indicative of the speed of multiple drivers when performing a given manoeuvre at the junction or intersection represented by the node, wherein the plurality of speed distribution profiles are indicative of the speed of multiple drivers when performing different maneuvers at the junction or intersection; and

using the data representative of the speed distribution profiles to provide a speed recommendation for a vehicle carrying out, or about to carry out, a manoeuvre at the junction or intersection.

The present invention in this further aspect may include any or all of the features described in relation to the other aspects of the invention to the extent to which they are not mutually inconsistent therewith.

In this further aspect of the invention data representative of multiple speed distribution profiles is associated with at least one node of a digital map representative of a junction or intersection. The multiple speed distribution profiles are different speed distribution profiles indicative of the speeds of multiple drivers when performing respective different maneuvers at the junction or intersection. For example, speed distribution profile data may be associated with a node representative of the speed distribution profiles for multiple drivers when turning left or right, or going straight ahead at the junction. This speed distribution profile data is used to provide a speed recommendation for a vehicle carrying out, or about to carry out the relevant manoeuvre at the junction or intersection.

In accordance with the invention of the second aspect, the junction or intersection of which the node having the speed distribution profile data is representative may be of any form. The junction or intersection may be represented by a single node, or may be a more complex intersection which may be represented by multiple nodes and segments in the digital map. Thus the node may be fully or partially indicative of the junction or intersection. In embodiments the method may be carried out with respect to a plurality of nodes, or each node of the digital map which is representative of a junction or intersection. A junction or intersection may be of any form, and may include a roundabout and/or crossing, etc.

In accordance with the invention in its second aspect, rather than data indicative of a speed distribution profile being associated with a plurality of positions along a given navigable segment indicative of a curve, data indicative of multiple speed distribution profiles is associated with a node of a digital map. Each speed distribution profile relates to the speed of multiple drivers when performing a particular (different) manoeuvre at the junction or intersection represented by the node. This speed distribution profile data is in contrast to merely associating speed profile data representative of a single average speed with the node for each manoeuvre. The speed distribution may relate to the speeds of drivers at any given reference position when carrying out the manoeuvre, e.g. at the node. Multiple speed distribution profiles may be associated with each manoeuvre relating to the speeds of drivers at different positions relative to the node when performing the manoeuvre. The methods described herein may then be carried out using any or all of these distributions, e.g. to provide guidance as the driver approaches the node and throughout the manoeuvre. In accordance with the invention, speed distribution profiles relating to the speeds of drivers when at one or more positions when carrying out the manoeuvre are used to provide the speed recommendation.

In embodiments the node is associated with data indicative of a plurality of maneuvers which may be performed at the junction or intersection represented by the node, and with data indicative of a respective speed distribution profile indicative of the speed of multiple drivers when performing the respective manoeuvre for each of the plurality of maneuvers. For example, the node may be representative of a junction where it is possible to turn left, turn right, or go straight ahead. Speed distribution profile data may then be associated with the node for each of the maneuvers. It will be appreciated that speed distribution profile data may be provided for speed distribution profiles associated with any or all of the possible maneuvers at the junction.

In accordance with the invention in either of its aspects, data is either associated with each of a plurality of positions along a navigable segment representative of a curve, the data for each position being representative of a speed distribution profile for the position, or is associated with a node, being representative of a plurality of speed distribution profiles, each relating to a different manoeuvre which may be performed at the junction or intersection represented by the node. Provided that it is indicative of the distribution of the (instantaneous) speeds of multiple drivers either at the position when travelling around the curve, or performing each relevant manoeuvre at the node, the speed distribution profile of which the data is indicative in accordance with either of the aspects of the invention may be of any suitable type. In relation to the first aspect of the invention, it will be appreciated that the speed distribution profile is based on data relating to drivers who passed through the position when travelling around the curve, rather than taking some other route. In accordance with the second aspect of the invention, the speed distribution profile data is indicative of a plurality of speed distribution profiles, each being based on data relating to drivers who performed a particular manoeuvre at the junction or intersection represented by a node.

In accordance with the invention in its different aspects, the speed distribution profile of which the data is indicative is based on the relevant speed distribution for the position (when travelling around the curve), or distributions (for each of the respective maneuvers) for the node. The speed distribution profile may be based on the relevant speed distribution or distributions in any manner. In some embodiments the or each speed distribution profile is the speed distribution. However, it need not be a complete speed distribution. In other embodiments the speed distribution profile is derived from the speed distribution. This may provide an appropriate balance between providing sufficient information to allow flexibility in deriving speed recommendations, and reducing the storage capacity needed to store the speed distribution profile data. This may also enable processing power to be conserved, potentially allowing recommendations to be generated more quickly and efficiently.

In embodiments, the or each speed distribution profile may be indicative of two or more percentile speeds. This may be achieved by using a profile which is the relevant full distribution from which the percentile speeds may be derived, or the profile could be the two or more percentile speeds. In the former case, an appropriate percentile speed may then be determined from the speed distribution profile for use in the speed recommendation step. In these embodiments each speed distribution profile may be indicative of two or more, preferably three or more, different predetermined percentile speeds. In this way, the speed recommendations based on the speed distribution profile data may be based upon speeds which a statistically significant population of drivers take at the relevant position when travelling around the curve or when performing a given manoeuvre at a junction or intersection represented by the node.

The percentile speeds preferably include a relatively higher percentile speed and one or more relatively lower percentile speeds. The relatively lower percentile speeds may include a lowermost percentile speed and one or more intermediate percentile speeds. The relatively higher percentile speed preferably is a 75th percentile speed or higher, and may be in the range of from an 80th to 95th percentile speed. By choosing the percentile speeds in these ranges, it has been found that appropriate recommended speeds may be determined, while excluding the effect of extreme driving speeds, e.g. unsafe high speeds etc. In embodiments, the speed distribution profile is indicative of a percentile speed being a 75th percentile speed or above, and additionally a relatively lower percentile speed or speeds. The relatively lower percentile speed or speeds may or may not be a significantly lower speed, and may comprise a 50th percentile speed or lower, or a 25th percentile speed or lower. It will be appreciated that the or each speed distribution profile may be indicative of any number of predetermined percentile speeds. The percentile speeds may or may not be spaced at even intervals. A greater number of percentile speeds may allow greater flexibility in tailoring speed recommendations to individual drivers. In one embodiment, the or each speed distribution profile includes 5th, 50th and 95th percentile speeds, respectively. The or each speed distribution profile may be the percentile speeds, or be somehow indicative thereof. It will be appreciated that where the or each speed distribution profile comprises a (full) speed distribution, percentile speeds in any of the above ranges may be derived from the speed distribution for use in providing the speed recommendation.

Whatever the form of the or each speed distribution profile, the data representing the or each speed distribution profile may be the speed distribution profile, or may be data otherwise describing the speed distribution profile or profiles, e.g. a mathematical function representing the speed distribution profile or profiles. For example, the data representing the speed distribution(s) may correspond to the or each speed distribution, or to a profile derived therefrom. Thus the data may be one or more speed distribution curves. The speed distribution may be a Gaussian distribution. However, in other embodiments, the data may be a mathematical function of a speed distribution for the position or each manoeuvre. The data may be two or more percentile speeds where the speed distribution profiles are indicative thereof.

In accordance with the invention in any of its aspects or embodiments, the or each speed distribution profile represented by the speed distribution profile data may be a profile obtained in any suitable manner. The or each speed distribution profile is a historical speed distribution profile indicative of the speeds of multiple drivers either travelling around a curve when at a given position, or performing a particular manoeuvre at a junction or intersection. The present invention may extend to determining the speed distribution profiles, although it will be appreciated that the techniques of the present invention may employ speed distribution profile data that may already be available, and does not necessarily require any specific data to be collected.

In embodiments the or each speed distribution profile (and hence the data indicative thereof) is based (at least in part) on vehicle probe data. The term “vehicle probe data” takes on its customary meaning in the art. Vehicle probe data refers to positional data collected from multiple vehicles, the positional data being associated with temporal data, e.g. a timestamp. The positional data collected from a given vehicle at different times may be used to provide a probe “trace” of the path taken by the vehicle. Probe data for a vehicle may be provided by a device associated with the vehicle capable of providing the positional and associated temporal data. Typically the device may comprise a Global Navigation Satellite Systems (GNSS) device, such as a GPS device. The probe data from different vehicles may be transmitted to a central controller, and, in this way, probe data from different vehicles can be collected.

It will be appreciated that standard techniques may be used to determine a speed distribution profile of the type desired based on vehicle probe data relating to the speeds of multiple drivers either at a given position along a navigable segment or while performing a particular manoeuvre at a node. For example, a distribution of the speeds of drivers at a given position or while performing a given manoeuvre may readily be extracted from probe data, or, as appropriate, a speed distribution profile of another type as discussed above, e.g. speed percentile values may be derived from a speed distribution for each position or manoeuvre. In embodiments in accordance with the first aspect of the invention, the positions associated with the speed distribution profile data in accordance with the invention will typically be spaced apart by distances greater than the typical spacing of probe data, allowing the necessary data for determining a speed distribution profile to be readily selected from available probe data.

Typically a process of determining a speed distribution profile for use in accordance with the first aspect of the invention would involve collecting the vehicle probe data representing instantaneous speed traveled for vehicles travelling around the curve through a given position, and carrying out some further processing, e.g. filtering of the probe data and binning the data into subsets representing intervals of instantaneous speeds traveled though the position. The resulting speed data may be used to provide a speed distribution profile in the form of speed distribution or otherwise representative of the speed distribution, e.g. incorporating various percentile speed values, etc. This may be repeated for other positions along a navigable segment or segments. Similar techniques may be employed in accordance with the second aspect of the invention, by collecting probe data representing instantaneous speed traveled for vehicles traversing a node in accordance with a particular manoeuvre, e.g. left turn, thereby providing a speed distribution for a given manoeuvre. The speed distribution may then be used as the speed distribution profile, or data derived from the distribution may be used as the profile. This may be repeated for each manoeuvre for which speed distribution profile data is required.

In accordance with the first aspect of the invention, speed distribution profiles may be obtained for a given position along the navigable segment representing the curve using probe data collected from vehicles which pass through the position as they travel around the curve. In this aspect, a speed distribution profile may be determined based upon the speeds of any vehicles travelling along the navigable segment. In accordance with the second aspect of the invention it is necessary to take into account the paths taken by vehicles to select data relating to vehicles performing a given manoeuvre at the node, rather than performing a different manoeuvre at the node in order to obtain a speed distribution profile for a given manoeuvre at the node.

In accordance with the invention in any of its aspects, regardless of the data upon which it is based, the or each speed distribution profile may be a speed distribution profile relevant under one or more different conditions, e.g. relevant to a particular time, road condition, lighting condition, weather condition, and/or lane traveled, etc. Speed distribution profiles of this type may be determined using speed data from multiple drivers, e.g. vehicle probe data collected under the relevant condition(s). In some embodiments, the or each speed distribution profile represents the speeds of the multiple drivers travelling under free flow conditions. Such conditions are conditions under which traffic can be considered to have no impact upon the speeds traveled by vehicles. This may be achieved by using data collected from vehicles travelling at night, when the segment or node is known to be free of traffic, or under other conditions under which it can be assumed that the vehicles were travelling at the fastest possible speeds.

In accordance with the invention in its first aspect, it is envisaged that each position might be associated with data representative of a set of speed distribution profiles for the position, each being indicative of the speeds traveled by multiple drivers travelling around the curve when at the position, wherein the set of speed distribution profiles includes speed distribution profiles indicative of the speeds traveled around the curve at the position by multiple drivers under different conditions, e.g. different road conditions, temporal conditions, etc. Speed recommendations may then be provided to a driver based on the appropriate speed distribution profile for a condition most closely representing current driving conditions. Similarly, in accordance with the second aspect of the invention, data indicative of multiple sets of multiple speed distribution profiles (for each of the different maneuvers at the node) may be associated with a node, each set of speed distribution profiles being applicable to a different set of conditions.

In accordance with the invention in its first aspect, the method involves using the speed distribution profile data to provide a speed recommendation for a vehicle travelling around, or about to travel around, i.e. approaching, the curve. Preferably a speed recommendation is provided at least when the vehicle is travelling around the curve. In accordance with the second aspect, the method involves providing a speed recommendation for a vehicle carrying out, or about to carry out, a manoeuvre at a junction or intersection. Preferably the speed recommendation is provided at least when the vehicle is carrying out the manoeuvre. In either of the aspects of the invention, preferably the speed recommendation is provided to a driver of the vehicle. In preferred embodiments of the invention in either aspect, the speed recommendation is provided using an apparatus having means for obtaining data indicative of a position of the apparatus, and being associated with, i.e. located in or on, the vehicle.

The present invention further extends to an apparatus being configured to carry out any or all of the steps of the method of providing a speed recommendation in accordance with either of the first or second aspects of the invention in any the embodiments herein described.

In accordance with a third aspect of the invention there is provided an apparatus positionable in a vehicle for providing a speed recommendation for the vehicle, the apparatus comprising:

means for obtaining position data indicative of a position of the apparatus;

means for accessing a digital map having data indicative of a plurality of navigable segments, the plurality of navigable segments including at least one navigable segment representative of a curve, and wherein the digital map further comprises data indicative of a plurality of positions along the navigable segment representative of a curve, each of the plurality of positions being associated with data representative of a respective speed distribution profile for the position, the speed distribution profile being indicative of the speed of multiple drivers at the position when travelling around the curve; and

means for using the data representative of a speed distribution profile to provide a speed recommendation for the vehicle when approaching or travelling around the curve.

The present invention in this further aspect may include any or all of the features described in relation to the other aspects of the invention, in particular the first aspect of the invention, to the extent it is not mutually inconsistent therewith. Thus the apparatus, e.g. navigation apparatus, may be configured to perform any of the optional and preferred steps of the method of the first aspect of the invention herein described. The means for carrying out any of the steps of the method may comprise a set of one or more processors configured, e.g. programmed, for doing so. A given step may be carried out using the same or a different set of processors to any other step. Any given step may be carried out using a combination of sets of processors.

In accordance with a fourth aspect of the invention there is provided an apparatus positionable in a vehicle for providing a speed recommendation for the vehicle, the apparatus comprising:

means for obtaining position data indicative of a position of the apparatus;

means for accessing a digital map having data indicative of a plurality of navigable segments and nodes, wherein at least some of the nodes are indicative of a junction or intersection, and wherein the digital map further comprises data indicative of a plurality of speed distribution profiles associated with at least one node, each speed distribution profile being indicative of the speed of multiple drivers when performing a given manoeuvre at the junction or intersection represented by the node, wherein the plurality of speed distribution profiles are indicative of the speed of multiple drivers when performing different maneuvers at the junction or intersection; and

means for using the data representative of the speed distribution profiles to provide a speed recommendation for the vehicle carrying out, or about to carry out, a manoeuvre at the junction or intersection.

The present invention in this further aspect may include any or all of the features described in relation to the other aspects of the invention, in particular the second aspect of the invention, to the extent it is not mutually inconsistent therewith. Thus the apparatus, e.g. navigation apparatus, may be configured to perform any of the optional and preferred steps of the second aspect of the invention herein described. The means for carrying out any of the steps of the method may comprise a set of one or more processors configured, e.g. programmed, for doing so. A given step may be carried out using the same or a different set of processors to any other step. Any given step may be carried out using a combination of sets of processors.

The apparatus used in accordance with these further aspects or embodiments of the invention to provide a speed recommendation may be of any suitable type. The apparatus may provide the speed recommendation when associated with a vehicle in any manner, e.g. mounted in or on, or being at least partially integrated with the vehicle. The apparatus may be a portable apparatus which may be located in the vehicle, or may be at least partially integrated with the vehicle. When the apparatus is positioned within the vehicle, it will be understood that the position of the apparatus will correspond to the position of the vehicle. The position data obtaining means may be of any suitable type. In some embodiments the apparatus may comprise position data determining means, e.g. GPS position determining means. However, in other embodiments the apparatus may be arranged to receive position data determined elsewhere, for example from a GPS position determining means of the vehicle. Thus the apparatus may simply be connected to a suitable position data input for obtaining the position data. It will be appreciated that the apparatus need not comprise route planning or mapping capability. However, in preferred embodiments the apparatus is a navigation apparatus. The navigation apparatus may comprise a display for displaying a digital map to a user, means for accessing digital map data and causing a digital map to be displayed to a user via the display, and a user interface operable by a user to enable the user to interact with the apparatus.

Any or all of the “additional” data, i.e. speed distribution profile data and optionally position data or manoeuvre data associated with the digital map data in accordance with the first and third aspects of the invention, or the speed distribution profile data and optionally manoeuvre data stored in accordance with the second and fourth aspects of the invention, may be stored together with digital map data, or may be stored separately to the digital map data, provided it is associated therewith.

In aspects or embodiments of the invention in which the speed recommendation is provided using an apparatus associated with a vehicle, the apparatus is configured to access the digital map data and the additional data. The apparatus may store the digital map data in a memory thereof. The apparatus may similarly store the additional data in a memory thereof. Alternatively, any or all of the additional data could be stored remotely from the apparatus and/or digital map data. For example, the apparatus may be configured to store only a digital map and not the additional data, or may store both the digital map data and the additional data, or both sets of data may be stored remotely from the apparatus. The apparatus may then be arranged to download the additional data associated with the map data as required, e.g. before or as a driver travels around the curve or performs a manoeuvre. For example, where the apparatus is a navigation apparatus, the relevant data may be downloaded for map segments or nodes of a planned route, or a route the navigation apparatus has inferred the driver is likely to be following. The apparatus could additionally download the digital map with the speed distribution profile data. By downloading the necessary data “on the fly” the amount of data that needs to be stored by the apparatus may be reduced.

In accordance with any of the aspects of the invention, a speed recommendation is preferably provided using the speed distribution profile data and additionally a current speed and/or current position of the vehicle. For example, in accordance with the present invention in accordance with the first aspect, the method preferably comprises determining the current position of the vehicle, and providing a speed recommendation for the vehicle when the current position approaches, or is located along the curve. Similarly, in accordance with the invention in its second aspect, the method preferably comprises determining a current position of the vehicle, and providing a speed recommendation for the vehicle when the current position approaches, or is located at the node representing the junction or intersection at which the manoeuvre is performed. Thus, in these different aspects, the speed recommendation can be provided automatically when the vehicle approaches or travels around the curve or intersection/junction.

These steps may be advantageously carried out by an apparatus having position data obtaining means associated with the vehicle, e.g. the apparatus of the third or fourth aspect of the invention. In these embodiments the apparatus has means for obtaining position data indicative of a current position of the apparatus. Thus when the apparatus is associated with, i.e. located in or otherwise mounted to a vehicle, the position of the apparatus may be taken to correspond to the position of the vehicle at any given time. The current position may be position indicated by any appropriate positioning signal, e.g. a GPS signal, and may be determined by the apparatus itself, or by an external apparatus and provided as an input to the apparatus.

Some embodiments of the first and third aspects of the invention in which the speed recommendation relates to travel around a curve will now be described in more detail. In accordance with the invention in its first or third aspect, the proximity to the curve or node at which a speed recommendation is provided, or is first provided, may be set as desired. In aspects or embodiments providing a speed recommendation for travel around a curve, preferably the speed recommendation is provided when the current position of the vehicle is located along the or a navigable segment which represents the curve. The speed recommendation may be triggered when the current position is at or within a predetermined distance of a given position on the curve, e.g. a start of the curve, mid point, etc. The method may further comprise monitoring the current position of the vehicle relative to the curve and providing the speed recommendation when the current position is at or within a predetermined distance of the curve. For example, the recommendation may be triggered when the current position comes within a predetermined distance of, or corresponds to a position on the navigable segment representing the curve with which speed distribution profile data is associated.

It will be understood that the current position data may be used in various ways together with the speed distribution profile data to provide a speed recommendation. In embodiments the current position may be used to select a speed distribution profile from those speed profiles associated with positions along the navigable segment representative of the curve for use in providing the speed recommendation. In some embodiments the method comprises providing a speed recommendation using a speed distribution profile associated with the current position of the vehicle, or a position ahead of the current position along the navigable segment. For example, a speed distribution profile for a position a predetermined distance ahead of the current position may be used, or a distance ahead which depends upon other factors, e.g. current speed, conditions, degree of curvature of the navigable segment, etc. A suitable algorithm may be used to control the selection based on desired criteria to ensure that sufficient time is given for the driver to react to the speed recommendation. Preferably the speed recommendation is provided using a speed distribution profile associated with a position along the or a navigable segment representing the curve, which navigable segment is a navigable segment along which the current position of the vehicle is located.

In preferred embodiments of the invention in accordance with the first or third aspect, the speed recommendation is provided using the speed distribution profile data and also (at least) a current speed of the vehicle. It will be appreciated that the current position of the vehicle may also be used. Thus, in embodiments, the speed recommendation is provided using one or more of the current position and current speed of the vehicle. In embodiments in which the recommendation uses a current speed of the vehicle, the method may comprise determining a current speed of the vehicle and using the current speed with the speed distribution profile data to provide the speed recommendation. The current speed may be used to trigger the providing of the speed recommendation and/or determine a timing for providing a speed recommendation as described in more detail below.

In these aspects and embodiments of the invention, the speed recommendation is provided using the speed distribution profile data associated with one or more of the positions along the or a navigable segment representing the curve. In preferred embodiments the method comprises using speed distribution profile data associated with multiple or each position along the navigable segment or segments representative of the curve to provide a speed recommendation.

It will be appreciated that the speed recommendation, whether provided on approach to a curve, or while travelling around the curve, or both, may be a single recommendation that is given only once. However, and more preferably, the method may comprise providing a speed recommendation at different times as the vehicle approaches and/or travels around the curve. The speed recommendation may be provided continually or intermittently during approach and/or travel around the curve. In embodiments the method comprises using speed distribution profile data associated with different positions along the navigable segment to provide a speed recommendation as the vehicle approaches and/or travels around the curve. For example, where the speed recommendation is dependent upon current position, it may change as the current position changes, being based on a speed distribution profile associated with a position along the navigable segment representing the curve a predetermined distance ahead at any given time.

In accordance with the invention, the method preferably comprises providing a speed recommendation at different times as the vehicle approaches and/or travels around the curve based on the speed distribution profile data and one or more of the current position of the vehicle and the current speed of the vehicle. In this way, the driver or vehicle may be guided as to an appropriate speed as they progress around the curve. This may take into account, for example, changes in the curvature of the curve.

Some embodiments of the second and fourth aspects of the invention in which the speed recommendation relates to a manoeuvre at a junction will now be described. In these aspects and embodiments of the invention, it will be appreciated that speed distribution profile data is associated with a node for each of a plurality of different maneuvers which may be carried out at the junction or intersection represented by the node. In embodiments the method comprises identifying a manoeuvre being performed, or about to be performed by the vehicle, and accessing speed distribution profile data relating to the manoeuvre for use in providing the speed recommendation. Thus, for any given manoeuvre, the relevant speed distribution profile data may be obtained from the multiple sets of speed distribution profile data associated with the node for use in providing the speed recommendation. The method may comprise accessing data indicative of a plurality of maneuvers associated with the node, and identifying which of the plurality of maneuvers is being performed by or about to be performed by the vehicle, and obtaining speed distribution profile data for the manoeuvre. In embodiments the node is associated with data indicative of a plurality of maneuvers which may be performed at the junction or intersection represented by the node, each manoeuvre being associated with the data indicative of a respective speed distribution profile for the given manoeuvre. The method may then comprise identifying the relevant manoeuvre being performed, or to be performed, and accessing the associated speed distribution profile data associated with the manoeuvre.

The manoeuvre may be identified in any suitable manner. For example, this may be determined by reference to a pre-planned or probable route of the vehicle. In embodiments the step of identifying a manoeuvre to be performed may be carried out by a navigation apparatus associated with the vehicle. The method may extend to determining the manoeuvre using a probable route type determination. The step of identifying the manoeuvre may comprise using a current speed of the vehicle. In some embodiments the method comprises using the current speed of the vehicle and the data indicative of the plurality of speed distribution profiles associated with the node to identify the manoeuvre. In embodiments the method may comprise comparing the current speed of the vehicle to a speed obtained from each speed distribution profile to identify a manoeuvre. For example, the speed may be compared to a corresponding speed, e.g. an 85 percentile speed, of each profile to determine which it most closely matches. The method may further comprise using the current position of the vehicle in identifying the manoeuvre.

In accordance with the second and fourth aspects of the invention, the speed recommendation may be provided when a current position of the vehicle is at, or approaches the node representing the junction or intersection, e.g. when the current position is at a predetermined distance from the node. The speed recommendation may, as described above in relation to the aspects of the invention relating to travel around a curve, be provided once, or may be provided continually or intermittently during the manoeuvre. Multiple speed distributions for a given manoeuvre, e.g. relating to positions leading up to the node or during the manoeuvre, may be used to provide speed recommendations over a longer distance on approach to the node, or during the manoeuvre itself.

In accordance with the invention in any of its aspects or embodiments, the speed recommendation may be of various types. In preferred embodiments the speed recommendation is provided to the driver of the vehicle. The speed recommendation may be any instruction, warning or alert. In these embodiments the speed recommendation may be provided to or caused to be provided to the driver via an apparatus associated with the vehicle.

In some embodiments the speed recommendation is an instruction in the form of a recommended absolute speed. Alternatively or additionally, in other embodiments the speed recommendation may be an instruction in the form of a recommended speed relative to a current speed of the vehicle. Thus, the recommended speed may be a recommended change in speed. The recommendation may be provided as a recommended quantitative change in speed. However, it will be appreciated that the recommendation may be a non-quantitative recommendation, i.e. an alert or warning. Such a recommendation may simply draw the drivers attention to their speed, or otherwise provide a prompt to adjust speed. This may be similar to the manner in which an alert or warning about a safety camera may be given.

The speed recommendation may be provided to the driver in any suitable manner or manners, preferably using a navigation apparatus, e.g. on a display thereof, or via a suitable speed recommendation delivery system of the vehicle, e.g. an instrument panel display. The recommendation may be in the form of a sensory signal or signals, e.g. one or more of a visual, tactile or audible recommendation. The recommendation may be graphical and/or textual. For example, a recommendation may be provided as a spoken and/or visual instruction. This is particularly applicable to quantitative recommendations, whether relative or absolute. Alternatively or additionally, a recommendation may be provided by a graphical symbol, a flashing icon or display, a change in colour of a part of a display, e.g. of the navigation apparatus or vehicle. For example, a part of a display indicating current speed may flash, change colour, etc to draw the drivers attention thereto. A recommendation may be an audible signal, e.g. in the form of a beep. This may be useful in particular for non-quantitative recommendations.

In accordance with the invention in any of its aspects or embodiments, the method comprises providing the speed recommendation for the vehicle, and the apparatus may be arranged for so doing, or for causing the speed recommendation to be provided in any of the manners described, e.g. via another apparatus or the vehicle, etc. The step of providing the speed recommendation involves determining and outputting the speed recommendation. While in the preferred embodiments described, the speed recommendation for the vehicle has been described as being provided to a driver, e.g. by a navigation apparatus or speed recommendation delivery system of the vehicle itself, it is envisaged that a speed recommendation need not be delivered to a driver. Alternatively or additionally the method may comprise using the speed recommendation to automatically control the speed of the vehicle as it approaches or travels around the curve or performs the manoeuvre. The automatic control of the vehicle may involve application of a braking system of the vehicle. In some embodiments a speed recommendation is additionally or alternatively provided as an input to an ADAS system of the vehicle, e.g. for automatic implementation of the recommendation. The input may be an acceleration or deceleration command to an ADAS system. In embodiments the input may be an input to a braking control module of an ADAS system. It will be appreciated that these embodiments may be implemented in conjunction with manual control of the speed by a driver. For example, the automatic control might intervene as a fail-safe if the driver fails to implement a speed recommendation. While the use of a navigation apparatus has been described with particular reference to embodiments in which the speed recommendation is provided to a driver, it is envisaged that a navigation apparatus could be alternatively or additionally used to provide a speed recommendation in embodiments for automatically controlling the speed of the vehicle, e.g. by providing an input to an ADAS system of the vehicle.

Regardless of the manner in which the speed recommendation is provided, the speed recommendation is provided in accordance with the first or third aspects of the invention using the speed distribution profile data associated with positions along the navigable segment representing a curve, the data being representative of a speed distribution profile indicative of the speeds of multiple drivers at the relevant position when travelling around the curve. In accordance with the second and fourth aspects of the invention, the recommendation is provided using the data representative of the speed distribution profiles associated with the node, and being indicative of the speeds of multiple drivers when performing a different manoeuvre at the junction or intersection represented by the node. In embodiments the data used is the data indicative of a speed distribution profile for an identified manoeuvre that the vehicle is carrying out, or about to carry out. Thus the data used is a selection from the data representing the multiple speed distribution profiles.

In accordance with the invention in any of its aspects or embodiments, the speed recommendation may be determined using the speed distribution profile data for a position or given manoeuvre as appropriate in various manners. The speed distribution profile data may simply be used to determine a maximum safe or recommended speed for the vehicle at the position or while carrying out the manoeuvre. As already stated, a speed recommendation to try to cause the driver to adopt this speed may be provided at the position or node with which the speed distribution profile data is associated, or at a suitable distance prior to the position or node to allow time to implement any change. Given that the speed distribution profile data is obtained using data relating to actual speeds driven by drivers at the position or node, this provides advantages over prior art techniques in which speed recommendations are determined using theoretical calculations, e.g. based on the geometry of a curve. However, the speed distribution profile data which is used in accordance with the present invention in its various aspects can be used to provide further advantages in that it is collected from multiple drivers at the position. Thus, it incorporates information relating to multiple possible speeds at which the curve may be traversed or the manoeuvre carried out. The data has not been averaged to provide a single historical speed value, such that this information regarding multiple drivers is not lost, and can be used to tailor recommendations to different drivers.

In preferred embodiments, the method comprises determining a speed recommendation for the vehicle, wherein the speed recommendation is based on the speed distribution profile data associated with a given position or manoeuvre. In some embodiments the method comprises making a selection of data from the data representing the speed distribution profile associated with a position or manoeuvre for use in determining the speed recommendation for the vehicle. It will be appreciated that any of the steps described herein involved in determining the speed recommendation are preferably carried out by an apparatus associated with the vehicle, e.g. by a set of one or more processors thereof, although it is envisaged that other options exist. For example, the speed recommendation could be determined remotely, e.g. by a central server, and transmitted to the apparatus for communication to the driver. The determining may be carried out by any suitable controller. It is envisaged that providing a speed recommendation in accordance with the first or third aspects of the invention may involve using the speed distribution profile data associated with multiple positions at once, or more preferably with one position at a time.

In accordance with the invention in its various aspects or embodiments, the step of making a selection of the data preferably comprises selecting data from the data representative of the speed distribution profile and being indicative of the speed or speeds at which a driver or drivers traveled at the position or node when carrying out the given manoeuvre, but not data indicative of a speed or speeds at which another driver or drivers traveled at the position or node when carrying out the manoeuvre. Thus, in these embodiments, the method involves using a selection of the data from the data representing the speed distribution profile in order to determine a speed recommendation, i.e. using some but not all of the available data. This is in contrast to the situation where a speed profile consisted of a single averaged speed value. In embodiments, when a speed recommendation is determined for a second different driver, a different selection of data may be made from the same speed distribution profile.

In preferred embodiments, the speed recommendation is based on a percentile speed obtained from the data representative of a speed distribution profile. In embodiments the method comprises obtaining a percentile speed from the speed distribution profile data to provide the speed recommendation. This may be done by deriving the percentile speed from a speed distribution profile comprising a speed distribution, or the speed distribution profile represented by the data for a given position or manoeuvre may be indicative of a plurality of percentile speeds. The method may then comprise selecting one of the percentile speeds for use in determining the speed recommendation. In these embodiments the speed recommendation is provided using only one of a plurality of percentile speeds and not the other percentile speed or speeds of which the speed distribution profile data is indicative. In other embodiments, the speed distribution profile may comprise a speed distribution. The method may then comprise selecting data representing a given percentile speed from the distribution for use in providing the speed recommendation.

The step of determining a speed recommendation for the driver using speed distribution profile data associated with a given position may comprise any suitable calculation. The speed recommendation may be based on the speed distribution profile data in any manner. The speed recommendation may be determined in accordance with predetermined criteria. For example, the recommendation may correspond to data obtained from the speed distribution profile, e.g. a percentile speed, or may be otherwise based on the speed distribution profile data, or data selected therefrom, e.g. to be a given amount or percentage lower or higher than a percentile speed value obtained from the speed profile. Again, the way in which the speed recommendation is determined may be governed by driver preferences or a driver profile.

In accordance with the invention in any of its aspects or embodiments, the speed recommendation is preferably specific to the driver of the vehicle. In preferred embodiments the speed recommendation takes into account driver preferences and/or a driver profile derived from driving behaviour of the driver. Accordingly, in preferred embodiments the speed recommendation is provided using the speed distribution profile data and also (at least) preferences of the driver of the vehicle and/or a driver profile derived from the driving behaviour of the driver. Thus, the driver preferences or profile may be used to determine the way in which a speed recommendation is determined using the speed distribution profile data for a given position or manoeuvre. This may be by controlling the way in which data is selected from the speed profile, e.g. which speed percentile is used and/or the way in which a recommendation is determined using data obtained from the speed distribution profile e.g. whether a percentile speed is used, or a value within a given range above or below the percentile speed. By way of example, a more aggressive driver may stipulate that they wish to maintain a speed around a curve or during a manoeuvre which corresponds to or is based upon the 95th percentile speed, while a less aggressive driver might specify that they prefer to use a 50th percentile speed. Other driver preferences which may be taken into account may relate to a desire to drive in an economical manner. The speed recommendation may balance the various preferences of the driver as appropriate. In other embodiments using a driver profile, it may similarly be determined whether the driver would prefer to take a lower or higher speed around the curve or during the manoeuvre depending upon their past behaviour. As used herein, a driver (behaviour) profile refers to the profile of a driver which is derived, i.e. automatically from the driving style or behaviour of a driver. Driver profiles of this type may be obtained in any conventional manner. Such profiles are often used in conjunction with ADAS systems.

It will be appreciated in accordance with any of its aspects or embodiments, a speed recommendation may be provided whenever the current position of a vehicle is at, or at a given distance from the curve or node, or may be provided only under certain situations, e.g. where the current speed exceeds a given threshold or differs by more than a given amount relative to a determined recommended speed. Thus a speed recommendation may be determined and only provided or output, e.g. to a driver or ADAS system, under certain circumstances.

In aspects or embodiments of the invention, the apparatus is a mobile apparatus. In embodiments the apparatus is located in or on the vehicle. The current location of the apparatus will thus correspond to the current location of the user/driver, (and vehicle). As mentioned above, the apparatus may or may not be a navigation apparatus, and may be separate from the vehicle or be, at least in part, integral therewith.

It will be appreciated that the apparatus referred to herein may comprise a set of one or more processors for carrying out any of the steps described. For example, the “means for” carrying out any of the steps may be a set of one or more processors. References to a processor may refer to a set of one or more processors.

In some preferred embodiments in which the apparatus is a navigation apparatus, the apparatus may be of any type. One particular area of utility is in relation to portable navigation devices (PND). In embodiments, therefore, the apparatus is an apparatus of a portable navigation device (PND). In accordance with a further aspect, the apparatus referred to in the aspects and embodiments of the invention above is a portable navigation device (PND).

The invention is also applicable to navigation apparatus which is provided as part of an integrated navigation system. For example the apparatus may form part of an in-vehicle integrated navigation system. Such a navigation apparatus may be in communication with an ADAS system of the vehicle.

Regardless of its implementation, a navigation apparatus used in accordance with aspects or embodiments of the present invention may comprise a processor, memory, and digital map data stored within said memory. The processor and memory cooperate to provide an execution environment in which a software operating system may be established. One or more additional software programs may be provided to enable the functionality of the apparatus to be controlled, and to provide various other functions. A navigation apparatus of the invention may preferably include GPS (Global Positioning System) signal reception and processing functionality. The apparatus may comprise one or more output interfaces by means of which information may be relayed to the user. The output interface(s) may include a speaker for audible output in addition to the visual display. The apparatus may comprise input interfaces including one or more physical buttons to control on/off operation or other features of the apparatus.

In other embodiments, the navigation apparatus may be implemented by means of an application of a processing device which does not form part of a specific navigation device. For example the invention may be implemented using a suitable computer system arranged to execute navigation software. The system may be a mobile or portable computer system, e.g. a mobile telephone or laptop.

The present invention extends to a computer program product comprising computer readable instructions executable to perform a method according to any of the aspects or embodiments of the invention, or to cause an apparatus to perform such methods.

The present invention extends to a computer program product comprising computer readable instructions executable that when run on an apparatus in accordance with any of the aspects or embodiments of the invention cause a set of one or processors of the apparatus to perform the steps of providing a speed recommendation for a vehicle, e.g. to a driver of the vehicle, approaching or travelling around a curve, or performing or about to perform a manoeuvre in accordance with any of the aspects or embodiments of the invention described herein.

The method further extends to the step of storing the data representative of a respective speed distribution profile for the position associated with each of the plurality of positions along the or a navigable segment representative of the curve, or, in accordance with other aspects of the invention, storing the data representative of a plurality of speed distribution profiles for the different maneuvers which may be performed at a node in association with the node. In these aspects the data may be stored in association with data indicative of a plurality of maneuvers which may be performed at the node. The data may be stored in a database. The database may be of any suitable type, and may be a distributed database or a single database. As discussed above, the step of storing the data may comprise an e.g. navigation apparatus storing the data e.g. in a memory thereof. However, in other embodiments, the data may be stored centrally e.g. by a central controller. The data may then be accessible to multiple navigation devices for use in providing speed recommendations.

In accordance with the first aspect of the invention, the method may further comprise defining the plurality of positions along the navigable segment representative of the curve, and associating the speed distribution profile data therewith. The step of defining the positions along the navigable segment(s) may comprise marking the positions in the digital map. The positions are positions on the digital, i.e. electronic, map which correspond to physical positions.

It will be appreciated that the data associated with the digital map in accordance with the invention in any of its aspects, i.e. the data defining the positions and the speed distribution profile data associated with the positions, or the data indicative of the speed distribution profiles for different maneuvers, may be associated with the digital map, e.g. with a data layer of the digital map or otherwise to provide a digital map enriched with the information. The data may be associated with the digital map in any manner that provides a link or association between the positions on the navigable segment(s) of the map or the node of the map and the data as appropriate such that the data is accessible via the digital map.

In accordance with the invention in any of its aspects or embodiments, the method may further comprise providing the digital map having its associated data.

The present invention extends to a system for carrying out the steps of the method in accordance with the invention in any of its aspects or embodiments.

Where not explicitly mentioned it will be appreciated that the invention extends to a system comprising means for carrying out the method steps herein described, and the method may comprise carrying out any of the steps referred to in relation to the system. The means for carrying out a step may be a set of one or more processors, and references to “means for” may be replaced by a reference to one or more processors for carrying out a step. Separate or common means may be provided for carrying out any or all of the steps. The present invention in these further aspects may include any or all of the features described in relation to the other aspects or embodiments. It will be appreciated that the means for providing the speed recommendation, and optionally the means for storing the digital map data, may be an apparatus having position data obtaining capability, such as a navigation apparatus. Wherever the digital map data is stored, the data associated with the digital map data may be stored separately from or together with the digital map data as already described.

It is believed that the storage of speed distribution profile data indicative of the speeds that multiple drivers have traveled at a given position along a navigable segments for a plurality of positions along a navigable segment is new and advantageous in its own right, and is applicable to situations other than where navigable segments represent a curve, and the context of providing speed recommendations for travel around a curve.

Thus, in accordance with a further aspect of the invention there is provided a method of creating map data comprising:

storing a digital map having data indicative of a plurality of navigable segments;

defining a plurality of positions along at least one of the navigable segments; and

storing data representative of a respective speed distribution profile in association with each of the plurality of positions along the navigable segment, the speed distribution profile being indicative of the speed of multiple drivers when at the position.

Preferably the navigable segment is representative of a curve, and the speed distribution profile is indicative of the speed of multiple drivers when at the position and travelling around the curve.

In accordance with yet another aspect of the invention there is provided a database comprising data representing a digital map comprising a plurality of navigable segments, the database further comprising data representing a plurality of positions along at least one of the navigable segments, and data representative of a speed distribution profile associated with each of the plurality of positions, the speed distribution profile being indicative of the speed of multiple drivers when at the position.

Preferably the navigable segment is representative of a curve, and the speed distribution profile is indicative of the speed of multiple drivers when at the position and travelling around the curve.

In accordance with a further aspect of the invention there is provided a method of creating map data comprising:

storing a digital map having data indicative of a plurality of navigable segments and nodes, wherein at least some of the nodes are indicative of a junction or intersection; and

storing data indicative of a plurality of speed distribution profiles associated with at least one node indicative of a junction or intersection, each speed distribution profile being indicative of the speed of multiple drivers when at the node.

Preferably each speed distribution profile is indicative of the speed of multiple drivers when performing a given manoeuvre at the junction or intersection represented by the node, wherein the plurality of speed distribution profiles are indicative of the speed of multiple drivers when performing different maneuvers at the junction or intersection. The method may comprise storing data indicative of a plurality of maneuvers which may be performed at the junction or intersection represented by the node in association with the node and/or the speed distribution data.

In accordance with yet another aspect of the invention there is provided a database comprising data representing a digital map having a plurality of navigable segments and nodes, wherein at least some of the nodes are indicative of a junction or intersection, the database further comprising data indicative of a plurality of speed distribution profiles associated with at least one node indicative of a junction or intersection, each speed distribution profile being indicative of the speed of multiple drivers when at the node.

Preferably each speed distribution profile is indicative of the speed of multiple drivers when performing a given manoeuvre at the junction or intersection represented by the node, wherein the plurality of speed distribution profiles are indicative of the speed of multiple drivers when performing different maneuvers at the junction or intersection. The database may further comprise manoeuvre data as outlined above.

In some embodiments, the digital map data is stored together with the speed distribution data, and optionally position data or manoeuvre data in the different aspects of the invention. The data may be stored by a central server or an apparatus having means for obtaining position data for the apparatus. Alternatively the speed distribution data and optionally position data or manoeuvre data may be stored remote from the digital map data. For example the digital map data may be stored locally, e.g. by an apparatus having means for obtaining position data for the apparatus, and the other data stored by a central server.

It is envisaged that the speed distribution profile data may be stored in association with each navigable segment or node of the digital map, or, in accordance with some embodiments, at least those navigable segments representing curves.

The database in any of these further aspects or embodiments of the invention using a database, may be of any suitable form. In some embodiments the database may be stored on a computer readable medium. The computer readable medium may be, for example, a diskette, CD ROM, ROM, RAM, flash memory or hard disk. For example, the database may be stored on a memory of an navigation apparatus or other apparatus having position data obtaining capability. The present invention extends to a computer readable storage medium storing the database. The database may be a database of a server. However, it will be appreciated that the database may alternatively be stored in more than one location, provided the relevant associations are provided between the data of the database. Thus the database may be a distributed database. For example, a digital map may be stored by a memory of an apparatus with the additional data relating to the speed distribution profiles for positions along a segment or segments of the map or relating to the speed distribution profiles at a node being stored remotely, e.g. by a server, and being obtained by the apparatus as needed.

The present invention in these further aspects may include any of the features described in relation to the earlier aspects of the invention to the extent that they are not mutually incompatible. The speed distribution profile data may be of any of the forms described above, e.g. indicative of percentile speeds, or being based on a speed distribution, etc.

It is believed that associating data representing speed distribution profiles of the type with which the present invention is concerned, i.e. data indicative of the speeds of multiple drivers, with positions along navigable segments, or associating multiple such speed distribution profiles for each of a plurality of different maneuvers with a node representing a junction or intersection, has further advantageous applications. The present invention thus extends to a method of using the stored data or database in any of the applications described below.

The ability to compare driver speed against a profile, e.g. distribution of other drivers speeds for different positions along a navigable segment, or for a given manoeuvre at a junction or intersection, may enable a more detailed driver behaviour profile to be established. The data may be used in driver coaching applications, to help train a driver to conform their behaviour to an improved or satisfactory profile with respect to speed selection, or to monitor progress toward a more “ideal” profile. Thus, the data may, in general be used to provide behavioural feedback to a driver. In accordance with some embodiments the method comprises using the stored data or database to determine a driver behaviour profile.

Knowledge of the speeds taken by multiple actual drivers at a sub navigable segment level, or when performing a manoeuvre at a junction or intersection may also be beneficial in providing more accurate and reliable eco-routing, range estimation and emission modelling. Speed changes over relatively small distances e.g. in urban driving, can have a significant impact upon fuel economy. The data in accordance with the invention allows these changes to be captured at a sub navigable segment level. Thus, in embodiments the data is used in providing an eco-route determination, range estimation and/or emission model.

Additionally, it has been found that the data can be used in numerous ADAS applications.

One particularly useful application of the data is in relation to the implementation of driver behaviour based insurance systems. Recently driver behaviour based insurance systems, such as “Pay As You Drive” (PAYD) type insurance systems, have gained in popularity. Such systems monitor driver behaviour, with penalties or bonuses being associated with certain driving behaviour. Behaviour may be monitored using a navigation apparatus or similar, able to monitor vehicle position and speed, and reports provided to the insurance provider. The behaviour may be monitored in respect of certain predetermined criteria deemed indicative of positive or negative behaviour. For example, when a driver exceeds a maximum legal speed limit, a penalty may be given. Penalties may also be given if the driver exceeds an agreed maximum mileage in a given period, or drives during the night for longer than a prescribed maximum period. On the other hand, when reports show that a driver has satisfied certain prescribed conditions, a bonus may be assigned, or at least continued insurance cover provided. Such schemes may enable younger or less experienced drivers to obtain insurance, albeit to satisfying certain prescribed criteria indicative of acceptable or limited driving, who would otherwise be unable to obtain insurance, at least at reasonable cost. Penalties or bonuses may be in the form of financial penalties or bonuses, or the assignation or withdrawal of penalty points, which might ultimately lead, e.g. to discontinuation of insurance cover.

In accordance with the present invention, the association of data representing speed distribution profiles indicative of the speed of multiple drivers with given positions along a navigable segment, or associating data representing multiple speed distribution profiles relating to different maneuvers with a node representing a junction or intersection, provides the opportunity to assess a driver behaviour, e.g. a PAYD type insurance subscriber, against “bulk” driver behaviour. For example, it can readily be determined whether a driver is exceeding a given speed threshold deemed to represent the highest appropriate speed based on the speed distribution profile for a position, e.g. a given percentile speed. On a more detailed level, changes, e.g. improvements, in driver behaviour might be inferred by consideration of some average measure of the driver's speed relative to the speed distribution of other drivers for different positions over time.

The present invention thus extends to the use of the method or database in accordance with the further aspects of the invention in a driver behaviour based insurance system. One application of the data of the present invention may comprise using the speed distribution data for one or more positions along a navigable segment of a digital map to set a recommended speed for vehicles travelling along the segment at the position, monitoring the speed of a driver subscribing to a behaviour based insurance system when travelling along the segment to obtain data regarding the speed of the driver relative to the recommended speed at a position or positions along the segment, and using the relative speed data as an input to a model of a user based insurance system. The techniques may be particularly, although not exclusively applicable to traversal of curves. Thus the navigable segment may be a navigable segment representative of a curve, e.g. a curve. Preferably speed distribution profile data is associated with multiple positions along a given navigable segment. The comparison of the driver's speed to the recommended speed may be carried out at multiple positions along the segment. The recommended speed may be a percentile speed, e.g. an 85th percentile speed.

Another application may comprise using the data representative of one or more speed distribution profiles associated with a node, and each being indicative of the speed of multiple drivers when performing a different manoeuvre at a junction or intersection represented by the node, to set a recommended speed for vehicles performing a manoeuvre at the junction or intersection represented by the node, monitoring the speed of a driver subscribing to a behaviour based insurance system when performing the manoeuvre to obtain data regarding the speed of the driver relative to the recommended speed, and using the relative speed data as an input to a model of a user based insurance system.

In accordance with a further aspect of the invention there is provided a method of providing driver behaviour based insurance comprising:

accessing a digital map having data indicative of a plurality of navigable segments, the plurality of navigable segments including at least one navigable segment representative of a curve, and wherein the digital map further comprises data indicative of a plurality of positions along the navigable segment representative of a curve, each of the plurality of positions being associated with data representative of a respective speed distribution profile for the position, the speed distribution profile being indicative of the speed of multiple drivers at the position when travelling around the curve;

using the speed distribution data to set a recommended speed for vehicles travelling around the curve for one or more of the positions; and

monitoring the speed of a subscriber driver when travelling around the curve to obtain data regarding the speed of the driver relative to the recommended speed at one or more of the one or more positions around the curve, and using the relative speed data as an input to a model of a user based insurance system.

Preferably the speed distribution profile data is associated with a plurality of positions along a segment. The recommended speed is preferably a speed relative to the speed distribution such as a percentile speed.

In accordance with a further aspect of the invention there is provided a method of providing driver behaviour based insurance comprising:

accessing a digital map having data indicative of a plurality of navigable segments and nodes, wherein at least some of the nodes are indicative of a junction or intersection, and wherein the digital map further comprises data indicative of a plurality of speed distribution profiles associated with at least one node, each speed distribution profile being indicative of the speed of multiple drivers when performing a given manoeuvre at the junction or intersection represented by the node, wherein the plurality of speed distribution profiles are indicative of the speed of multiple drivers when performing different maneuvers at the junction or intersection;

using the speed distribution data to set a recommended speed for vehicles performing a given manoeuvre at the junction or intersection represented by the node; and

monitoring the speed of a subscriber driver when performing the manoeuvre at the junction or intersection represented by the node to obtain data regarding the speed of the driver relative to the recommended speed, and using the relative speed data as an input to a model of a user based insurance system.

The recommended speed is preferably a speed relative to the speed distribution such as a percentile speed.

The present invention in accordance with these further aspects may include any or all of the features described in relation to the other aspects of the invention to the extent it is not mutually inconsistent therewith.

The insurance model may be a model associated with any aspect of the insurance system, e.g. a premium setting model or a risk assessment model etc. The speed distribution profile may be of any of the forms described herein. Thus, in some embodiments, the speed distribution profile may be indicative of one or more percentile speeds, and the step of setting a recommended speed may comprise setting a recommended speed based on one of the percentile speeds. In other embodiments the speed distribution profile may be based on a speed distribution, and the step of setting a recommended speed may be a percentile speed derived from the speed distribution data.

In accordance with any of the further applications of the data methods or database of the invention, i.e. not being specific to speed recommendations for travel around a curve, the speed distribution profile data may be chosen as appropriate for the given application. For example, while in curve driving applications, the primary interest may be in the maximum safe or preferred speed for travel around the curve, in other applications, lower speeds may be of interest. For example, speed distributions may be used, or percentile speed information stored relating to lower speeds such as a 5th percentile speed or at least lower than a 25th percentile speed in applications for monitoring driver behaviour, or probable route determination, etc.

The present invention extends to a computer program product comprising computer readable instructions executable to perform a method according to any of the aspects or embodiments of the invention, or to cause a navigation apparatus to perform such methods.

It will be appreciated that, if not explicitly stated, the present invention in accordance with any one of the aspects described may include any of the features described in relation to any other aspect or aspects of the invention.

References to data being “indicative of” or “representative of” may be used interchangeably herein.

Advantages of these embodiments are set out hereafter, and further details and features of each of these embodiments are defined in the accompanying dependent claims and elsewhere in the following detailed description.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 is a schematic illustration of a Global Positioning System (GPS);

FIG. 2 is a schematic illustration of electronic components arranged to provide a navigation device;

FIG. 3 is a schematic illustration of the manner in which a navigation device may receive information over a wireless communication channel;

FIG. 4 is an illustrative perspective view of a navigation device;

FIG. 5 illustrates the steps involved in associating position and speed distribution profile data with a digital map in accordance with one embodiment of the present invention;

FIG. 6 illustrates the steps involved in using the speed distribution profile data to provide a speed recommendation in accordance with an embodiment of the invention;

FIGS. 7A and 7B illustrate a curved navigable segment and speed distributions associated with positions A, B and C along the navigable segment respectively in accordance with the methods of the present invention.

### DETAILED DESCRIPTION OF PREFERRED EMBODIMENTS

Preferred embodiments of the present invention will now be described with particular reference to a PND. It should be remembered, however, that the teachings of the present invention are not limited to PNDs but are instead universally applicable to any type of processing device that is configured to execute navigation software so as to provide navigation functionality. It follows therefore that in the context of the present application, a navigation device is intended to include (without limitation) any type of navigation device, irrespective of whether that device is embodied as a PND, a navigation device built into a vehicle, or indeed a computing resource (such as a desktop or portable personal computer (PC), mobile telephone or portable digital assistant (PDA)) executing navigation software. In addition, the present invention is applicable to devices with the ability to obtain position data for the device, but which may not provide navigation or route planning functionality. For example, such a device could be located in a vehicle, and arranged to provide speed recommendations via an instrument panel of the vehicle, obtaining position data from the vehicle or a position determining, e.g. GPS system of the device itself.

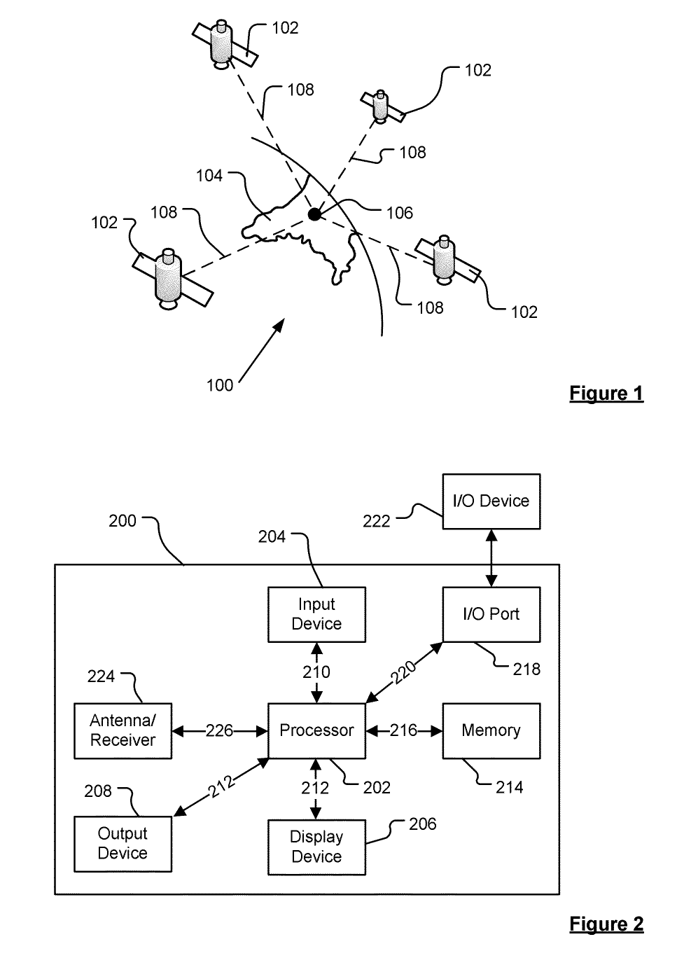

With the above provisos in mind, FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 102 are in orbit about the earth 104. The orbit of each satellite 102 is not necessarily synchronous with the orbits of other satellites 102 and, in fact, is likely asynchronous. A GPS receiver 106 is shown receiving spread spectrum GPS satellite signals 108 from the various satellites 102.

The spread spectrum signals 108, continuously transmitted from each satellite 102, utilize a highly accurate frequency standard accomplished with an extremely accurate atomic clock. Each satellite 102, as part of its data signal transmission 108, transmits a data stream indicative of that particular satellite 102. It is appreciated by those skilled in the relevant art that the GPS receiver device 106 generally acquires spread spectrum GPS satellite signals 108 from at least three satellites 102 for the GPS receiver device 106 to calculate its two-dimensional position by triangulation. Acquisition of an additional signal, resulting in signals 108 from a total of four satellites 102, permits the GPS receiver device 106 to calculate its three-dimensional position in a known manner.

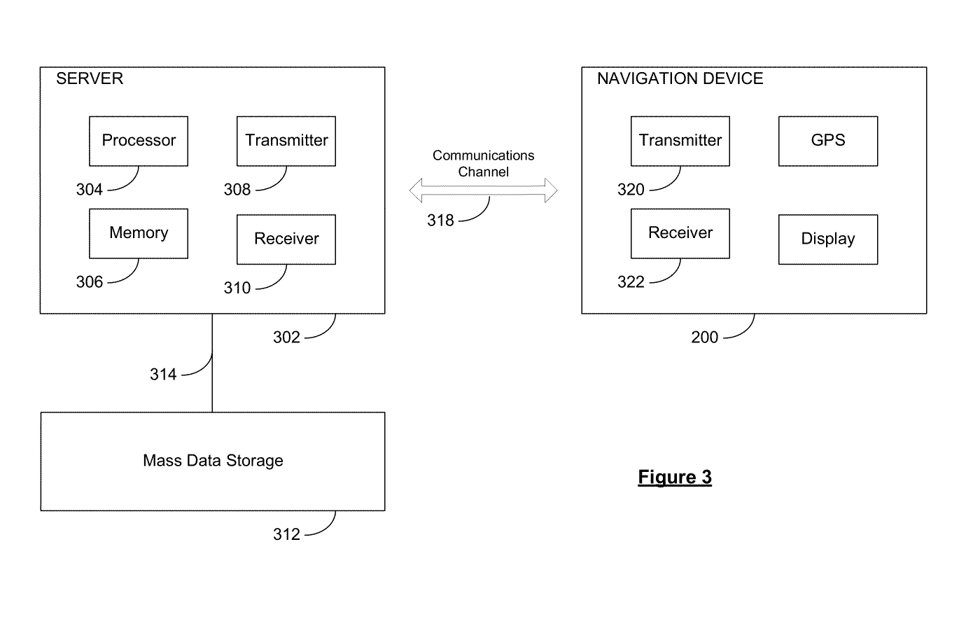

FIG. 2 is an illustrative representation of electronic components of a navigation device 200 according to a preferred embodiment of the present invention, in block component format. It should be noted that the block diagram of the navigation device 200 is not inclusive of all components of the navigation device, but is only representative of many example components.

The navigation device 200 is located within a housing (not shown). The housing includes a processor 202 connected to an input device 204 and a display screen 206. The input device 204 can include a keyboard device, voice input device, touch panel and/or any other known input device utilised to input information; and the display screen 206 can include any type of display screen such as an LCD display, for example. In a particularly preferred arrangement the input device 204 and display screen 206 are integrated into an integrated input and display device, including a touchpad or touchscreen input so that a user need only touch a portion of the display screen 206 to select one of a plurality of display choices or to activate one of a plurality of virtual buttons.

The navigation device 200 may include an output device 208, for example an audible output device (e.g. a loudspeaker). As output device 208 can produce audible information for a user of the navigation device 200, it is should equally be understood that input device 204 can include a microphone and software for receiving input voice commands as well.

In the navigation device 200, processor 202 is operatively connected to and set to receive input information from input device 204 via a connection 210, and operatively connected to at least one of display screen 206 and output device 208, via output connections 212, to output information thereto. Further, the processor 202 is operably coupled to a memory resource 214 via connection 216 and is further adapted to receive/send information from/to input/output (I/O) ports 218 via connection 220, wherein the I/O port 218 is connectable to an I/O device 222 external to the navigation device 200. The memory resource 214 comprises, for example, a volatile memory, such as a Random Access Memory (RAM) and a non-volatile memory, for example a digital memory, such as a flash memory. The external I/O device 222 may include, but is not limited to an external listening device such as an earpiece for example. The connection to I/O device 222 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

FIG. 2 further illustrates an operative connection between the processor 202 and an antenna/receiver 224 via connection 226, wherein the antenna/receiver 224 can be a GPS antenna/receiver for example. It will be understood that the antenna and receiver designated by reference numeral 224 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered to be within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a vehicle such as a bicycle, a motorbike, a car or a boat for example. Such a navigation device 200 is then removable from the docked location for portable or handheld navigation use. As an example, FIG. 4 shows a navigation device 200 that may sit on an arm 252, which itself may be secured to a vehicle dashboard, window, etc using a suction cup 254. This arm 252 is one example of a docking station to which the navigation device 200 can be docked. The navigation device 200 can be docked or otherwise connected to the arm 252 of the docking station by snap connecting the navigation device to the arm, for example. To release the connection between the navigation device 200 and the docking station, a button on the navigation device 200 may be pressed, for example. Other equally suitable arrangements for coupling and decoupling the navigation device to a docking station are well known to persons of ordinary skill in the art.

Referring now to FIG. 3, the navigation device 200 may establish a “mobile” or telecommunications network connection with a server 302 via a mobile device (not shown) (such as a mobile phone, PDA, and/or any device with mobile phone technology) establishing a digital connection (such as a digital connection via known Bluetooth technology for example). Thereafter, through its network service provider, the mobile device can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device (via a service provider) and another device such as the server 302, using an internet (such as the World Wide Web) for example, can be done in a known manner. This can include use of TCP/IP layered protocol for example. The mobile device can utilize any number of communication standards such as CDMA, GSM, WAN, etc.

As such, an internet connection may be utilised which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet).

The navigation device 200 can further complete a data connection with the mobile device, and eventually with the internet and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, or optionally using the internal antenna of the navigation device 200). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet for example, in a manner similar to that of any mobile device.

For GPRS phone settings, a Bluetooth enabled navigation device may be used to correctly work with the ever changing spectrum of mobile phone models, manufacturers, etc; model/manufacturer specific settings may be stored on the navigation device 200, for example. The data stored for this information can be updated.

In FIG. 3 the navigation device 200 is depicted as being in communication with the server 302 via a generic communications channel 318 that can be implemented by any of a number of different arrangements. The server 302 and a navigation device 200 can communicate when a connection via communications channel 318 is established between the server 302 and the navigation device 200 (noting that such a connection can be a data connection via mobile device, a direct connection via personal computer via the internet, etc).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver.

Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fibre optic cables, converters, radio-frequency (RF) waves, the atmosphere, empty space, etc. Furthermore, the communication channel 318 can include intermediate devices such as routers, repeaters, buffers, transmitters, and receivers, for example.

In one illustrative arrangement, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc. In other embodiments, the server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated automatically or upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

FIGS. 1 to 4 are provided by way of background, illustrating certain features of navigation apparatus which may be used to implement methods of the present invention.

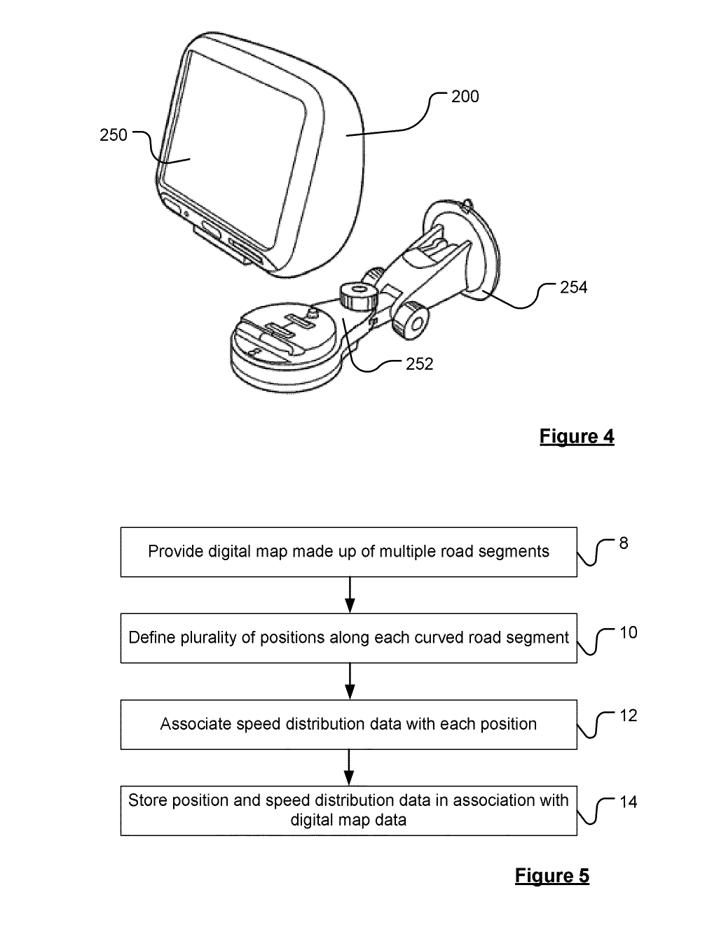

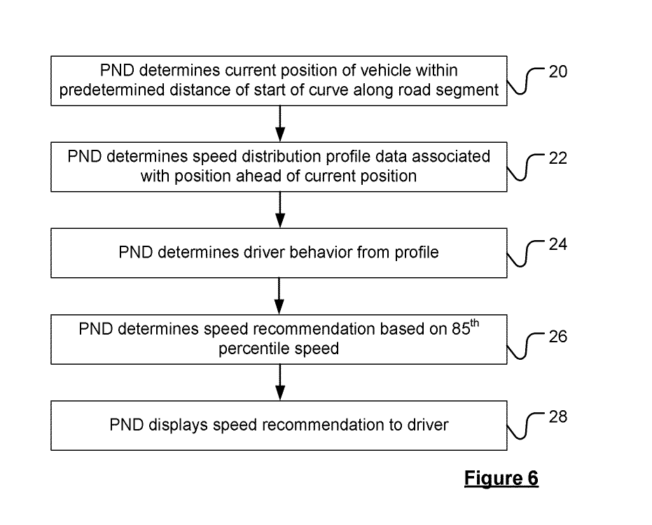

A preferred embodiment of the invention will now be described by reference to FIGS. 5 and 6.

The way in which speed distribution profile data is associated with digital map data in accordance with one embodiment of the invention will now be described by reference to FIG. 5.

A digital map is provided made up of multiple navigable segments connecting nodes—step 8. The following steps are carried out in relation to each navigable segment of the digital map which is curved, thus representing a curve.

A plurality of positions are defined along the curved navigable segment of the digital map—step 10. The positions are located at regularly spaced intervals along the length of the navigable segment, e.g. every 50 m. The plurality of positions are in the form of discrete points.

The following steps are carried out for each position along a segment. Speed distribution profile data is associated with the position—step 12. The speed distribution profile data is data representative of a speed distribution of the instantaneous speeds of multiple drivers when passing through the position along the curved navigable segment. The speed distribution profile data is in the form of a curve representing the speed distribution, which may be for example a Gaussian distribution. The speed distribution is obtained from probe data relating to the travel of multiple vehicles along the navigable segment under free flow conditions. This step of associating speed distribution profile data with the position is repeated for each of the positions defined along the navigable segment.

After steps 10 and 12 have been carried out, each of multiple positions along each navigable segment in the digital map representative of a curve has been associated with speed distribution profile data indicative of a speed distribution.

The result is a digital map enhanced with the speed distribution profile data. The digital map is stored in conjunction with the speed distribution profile data and position data—step 14. In the exemplary embodiment, the data is stored by a memory of a personal navigation device (PND). However, in particular depending upon the application of the data, other storage arrangements may be used. The data may be stored in a distributed database, and may at least in part be stored by a central server. In embodiments a PND may download the enhancing data i.e. speed distribution profile and position data for portions of a locally stored digital map as required, e.g. for a pre-planned route, or a probable route.

Of course, there are various alternatives and options which may be used when carrying out the method illustrated by reference to FIG. 5. While the method has been illustrated by reference to storing speed distribution profile data in association with positions along curved navigable segments, the same steps may be carried out with respect to other types of, or all navigable segments, providing a map in which additional or all navigable segments are enhanced with speed distribution profile data. This can be particularly useful in the context of certain further applications of the invention discussed below, not specific to speed recommendation around a curve.

The speed distribution profile data may be representative of a speed distribution obtained from probe data under various conditions for travel through the position along the navigable segment. The probe data relates to vehicles which traveled along the navigable segment on a route which continues around the curve. If desired, the probe data used to obtain the speed distribution profile may be selected in accordance with certain criteria e.g. relating to a certain time of day, season, lighting condition, type of vehicle etc. so as to provide a speed distribution profile relevant to the particular condition or conditions. This may allow speed recommendations to be provided for a particular set of conditions. Multiple speed distribution profiles may be associated with each position for different conditions. This would enable a selection to be made, e.g. by a PND of a particular speed distribution profile to use in a given set of conditions, or according to driver preferences.

Rather than associating a speed distribution profile in the form of a complete speed distribution curve with each point, the speed distribution profile may be associated with a mathematical description of the speed distribution, or with information based on the speed distribution profile and indicative of the speeds of multiple drivers. In another example, the speed distribution profile associated with each position includes at least two speed percentile values, such as 50th percentile and 85th percentile speeds. In a particularly preferred embodiment the speed distribution profile associated with each position includes the 5th, 50th and 95th percentile speeds. This may reduce the amount of data that needs to be stored. However, storing a complete speed distribution may provide greater flexibility in the determining of speed recommendations based on the speed distribution profile.

One way in which the enhanced digital map obtained using the method of FIG. 5 may be used to provide a speed recommendation using a PND in accordance with one exemplary embodiment of the invention will now be described by reference to FIG. 6.

The PND is located in a vehicle approaching a curve represented by a curved navigable segment of the digital map. The PND monitors the current position of the device and hence vehicle. In step 20 the PND determines that the current position of the vehicle has reached a position along a navigable segment within a predetermined distance of the start of a curve. In step 22 the PND determines a speed distribution profile associated with a position along the navigable segment a predetermined distance ahead of the current position. The PND determines the speed recommendation using the speed distribution profile data and additionally taking into account the drivers preferences or behaviour profile. In step 24 the PND determines from a driver behaviour profile that the driver is relatively aggressive. In this situation the PND extracts the 85th percentile speed from the speed distribution profile, i.e. distribution for the position, and determines a speed recommendation in accordance with the 85th percentile speed—step 26. The PND provides the speed recommendation to the driver via a display thereof—step 28. The speed recommendation is provided as an absolute speed recommendation, and an indication is also given as to the required change in current speed to achieve the recommendation. This is done using an appropriate visual indication, and may be combined with an audible signal e.g. a spoken instruction.

As the driver progresses around the curve, this process is repeated, with the PND continually providing a speed recommendation based on the speed distribution profile data associated with a position along the navigable segment a predetermined distance ahead of the current position to conform to an 85th percentile speed value. In this way, the driver is provided with the necessary information to travel around the curve in accordance with the 85th percentile speed as indicated by the speed distribution based on the historical speeds traveled around the curve by multiple other drivers.

It will be appreciated that if the driver has specified another preference, or if a driver profile indicates a more timid driver, the PND may determine a different speed recommendation based on the same speed distribution profile data associated with a position. This is because the speed distribution profile is indicative of the speed of multiple drivers passing through the position. Thus, if it is determined that the driver is relatively timid, rather than extracting the 85th speed percentile from the speed distribution, the PND may instead extract the 50th percentile speed, and provide recommendations in accordance with this speed. The driver profile referred to herein is a driver profile determined based on the drivers behaviour, e.g. such as may be inferred by an ADAS system. A driver preference refers to a driver specified preference or profile.

It will be appreciated that the speed recommendation may not necessarily correspond to a percentile speed indicated by the speed distribution profile, or derivable therefrom, but may be the result of some calculation using the data e.g. percentile speed obtained from the speed distribution profile e.g. a speed differing by a given amount or percentage from the data indicated by the profile, e.g. 10% lower than the 85th percentile, etc.

Rather than, or in addition to providing a recommendation to the driver that is to be implemented by the driver, the PND may provide an output in the form of an acceleration or deceleration command to an advanced driver assistance system (ADAS) module of the vehicle to enable a speed recommendation to be implemented automatically. Such arrangements would be particularly applicable if a navigation apparatus in the form of an integrated in-vehicle navigation apparatus were used rather than a PND. It will be appreciated that such navigation apparatus may be used in any of the embodiments of the invention instead of a PND type device.

It will be appreciated that the speed recommendation may not be provided to a driver or used to control the speed of the vehicle in all situations. The PND may compare the determined recommended speed to the current speed, and output the recommendation to the driver or an ADAS system only when the current speed differs from the recommended speed by an amount greater than a predetermined threshold.

It will be appreciated that the conditions under which a speed recommendation is provided, i.e. whether this is done before the start of the curve, at the start of the curve or otherwise, and whether a recommendation is provided throughout travel around the curve may be selected as desired.

It will also be appreciated that it is not necessary for the method to involve the use of a PND type or other navigation device. Instead the methods may be implemented by an apparatus associated with a vehicle which is able to obtain its own position and hence that of the vehicle, either through its own GPS positioning ability, or through an input from such a positioning means of the vehicle. The apparatus may cause a speed recommendation to be delivered via an output interface of the vehicle, e.g. an instrument panel.

A further embodiment of the invention will now be described. In accordance with this further embodiment, rather than associating a speed distribution profile with different positions along a curved navigable segment, instead multiple speed distribution profiles are associated with a node of a digital map which represents an intersection or junction. The digital map is made up of multiple navigable segments and nodes, some of which represent junctions or intersections. This method may be implemented with respect to any or all nodes representing a junction or intersection.

At the node, a number of maneuvers may be performed. The node is associated with data defining each possible manoeuvre, e.g. a left turn, right turn, straight ahead etc. A speed distribution profile is determined for each possible manoeuvre, describing the speeds of different drivers when performing the manoeuvre. Each distribution profile may be in the form of a Gaussian curve as described above, and may be obtained using probe data. The speed distribution profile may describe the speeds of drivers performing the manoeuvre at any given point, e.g. at the node or some other reference point. Multiple speed distribution profiles may be stored for each manoeuvre relating to the speeds of drivers at different positions relative to the node when performing the manoeuvre. This may allow more detailed speed guidance to be given.

When a driver approaches a junction, it is determined by a PND (or other device as described above) that the driver is to perform a particular manoeuvre at the junction. This may be done by reference to a pre-planned route, or a probable route estimation. The PND monitors the current position of the vehicle, and when it is within a given distance of the node, uses the speed distribution profile associated with the identified manoeuvre to provide a speed recommendation. This may be done as described in respect of the earlier curve guidance embodiment, e.g. by taking into account a driver profile or preferences. For example, the PND may obtain the 85th percentile speed for performing the manoeuvre, and instruct the driver accordingly to try to perform the manoeuvre in accordance with this profile. The speed recommendation may be provided in any of the manners described in relation to the earlier embodiment.

As may be seen by the above examples, the present invention provides a speed recommendation based on speed distribution profiles indicative of speed drivers have previously driven around a curve, or performed a manoeuvre. Thus, a greater level of confidence may be provided that the recommendations are appropriate and realistic, and complex theoretical calculations based e.g. on curve geometry are avoided. Factors such as visibility, which may be difficult to account for using conventional techniques, and which may be subjective, may be automatically accounted for. As the speed distribution profile data reflects speeds taken by multiple drivers, the present invention provides the ability for different speeds to be recommended to different drivers according to preferences or driver profiles.

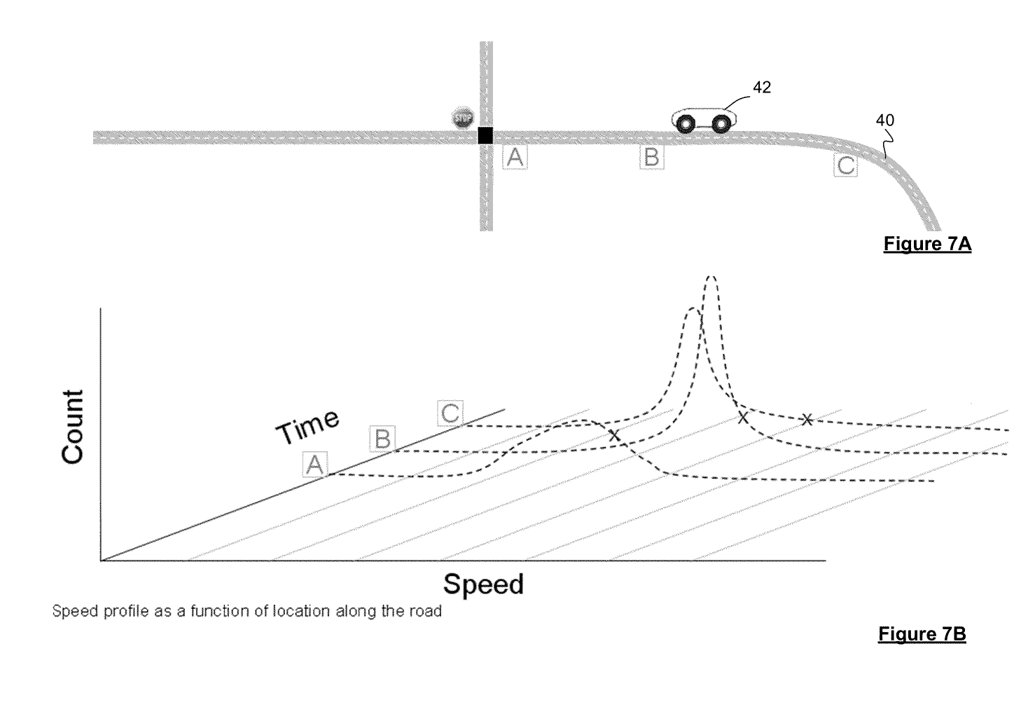

FIGS. 7A and 7B illustrate the way in which the speed distribution profiles associated with different positions along a navigable segment which is curved may be used to provide a varying speed recommendation as a driver travels along the navigable segment. Referring to FIG. 7A which schematically illustrates the curved navigable segment 40 and a vehicle 42 travelling along the navigable segment, positions A, B and C have been associated with a representation of the navigable segment in a digital map. The positions A to C are spaced apart along the length of the navigable segment. FIG. 7B illustrates the speed distributions associated with positions A, B and C respectively. It may be seen that these differ from one another, with there being a flatter distribution, indicating a greater spread of speeds for position A, at the start of the straight end of the navigable segment 40, and sharper spiked distributions at points B and C, approaching and on the curved portion. The speeds at point C are relatively lower than those for position B, but both are higher than at position A which is shortly after a stop at a junction.

In accordance with the above described embodiment, the speed recommendation at each point is given corresponding to the 85th percentile value as determined from the speed distribution for each position. It will be seen that a speed recommendation based on any other desired percentile speed or other value derived from the speed distribution could instead be used.

While the above preferred embodiments have been described by reference to guidance around a curve, data of the type obtained from the process of FIG. 5 may be used for other purposes.

One useful application is in the context of a driver behaviour based insurance system. The data obtained by the process of FIG. 5 provides the ability to determine the bulk speed behaviour of drivers at different positions along curved navigable segments. In one exemplary method, a prescribed maximum safe speed around a curve may be determined relative to the speed distribution for each point. For example, it may be determined that the maximum safe speed around a curve corresponds to the 85th percentile speed. As a subscriber to the insurance system drives along, a PND or other similar device may compare their speed at each position along the curved navigable segment to the 85th percentile speed derived from the speed distribution associated with the position. When it is determined that the current speed exceeds the 85th percentile speed, the PND or similar device may log this event for uploading as part of a driver behaviour report to the insurance provider. This may be used by the provider to assign penalty points, similar to the way in which exceeding speed limits, or driving during prohibited hours may be reported and used in conventional driver based insurance systems. Similarly, in accordance with other embodiments, speed distribution data relating to maneuvers at a junction or intersection may be used to set a recommended speed for the manoeuvre, and the speeds of subscribers to an insurance system may be compared to the recommended speed when performing the manoeuvre, and used to provide data for use by the insurance provider.

As mentioned above, the present invention is not limited to associating speed distribution profiles with curved navigable segments or nodes. The techniques of FIG. 5 may be applied to other types of navigable segment, with speed distribution profile e.g. speed distribution data being associated with positions along the length of the segments. Thus a digital map with all or at least a subset of navigable segments enhanced with speed distribution data at intervals along the navigable segments may be provided. Knowledge of speed distributions based on historical probe data for different positions along a given navigable segment may be used to compare the speed of a driver to the historical distribution for the corresponding position in numerous applications, not limited to insurance applications. This provides the ability to ascertain where the drivers behaviour lies in comparison to the behaviour of multiple drivers indicated by the speed distributions. This may be used to derive a more accurate driver behaviour profile and/or for use in providing feedback to a driver in driver coaching or training applications. The driver may be provided with a display of their current speed superposed on a speed distribution for each position as they travel along a navigable segment.

One example of such a technique can be illustrated by reference to FIGS. 7A and 7B. In this case, let us now assume that the driver is driving along the segment 40 without speed recommendations, using their own judgment as to speed. In one example, the driver may record speeds relative to the speed distribution at each of points A, B and C denoted by the marked positions “X” on each speed distribution. It can be seen that at positions B and C, the driver has selected a speed right at the upper tail of the speed distribution. This information could be used to provide feedback to a driver or an insurer, for example illustrating that a speed was taken around the curve which lies above a prescribed limit e.g. an 85th percentile speed.

It will be appreciated that the present invention in accordance with certain embodiments provides detailed information regarding speed at a sub segment level which is useful in capturing the variations that may occur along the same segment. Such detail is not obtainable from conventional segment or link speed profiles. This data may be used in eco-routing, range estimation and most probable path determination applications.

It will be appreciated that whilst various aspects and embodiments of the present invention have heretofore been described, the scope of the present invention is not limited to the particular arrangements set out herein and instead extends to encompass all arrangements, and modifications and alterations thereto.

Similarly, whilst embodiments described in the foregoing detailed description refer to GPS, it should be noted that the mobile devices 200, e.g. navigation apparatus, may utilise any kind of position sensing technology as an alternative to, or indeed in addition to, GPS. For example, the navigation apparatus may utilise other global navigation satellite systems, such as the European Galileo system. Equally, it is not limited to satellite-based systems, but could readily function using ground-based beacons or other kind of system that enables the device to determine its geographic location.

It will also be well understood by persons of ordinary skill in the art that whilst the preferred embodiment may implement certain functionality by means of software, that functionality could equally be implemented solely in hardware (for example by means of one or more SICs (application specific integrated circuit)) or indeed by a mix of hardware and software.

Lastly, it should be noted that whilst the accompanying claims set out particular combinations of features described herein, the scope of the present invention is not limited to the particular combinations hereafter claims, but instead extends to encompass any combination of features or embodiments herein disclosed irrespective of whether or not that particular combination has been specifically enumerated in the accompanying claims at this time.

1. A method of providing driver behaviour based insurance comprising:
accessing a digital map having data indicative of a plurality of navigable segments, wherein the digital map further comprises data representative of a speed distribution profile for one or more positions along at least one of the navigable segments, the speed distribution profile for a position being indicative of the speed of multiple drivers at the position;
using the data representative of a speed distribution profile to set a recommended speed for vehicles travelling along the at least one navigable segment; and
monitoring the speed of a subscriber driver when travelling along the at least one navigable segment to obtain data regarding the speed of the driver relative to the recommended speed for at least one of the one or more positions, and using the relative speed data as an input to a model of a user based insurance system.

2. The method of claim 1, wherein the navigable segment is representative of a curve.

3. The method of claim 1, wherein the position along the at least one navigable segment represents a junction or intersection, and wherein the data representative of a speed distribution profile for the position comprises data indicative of a plurality of speed distribution profiles, each speed distribution profile being indicative of the speed of multiple drivers when performing one of a plurality of possible maneuvers at the junction or intersection.

4. The method of claim 3, comprising identifying a manoeuvre being performed, or about to be performed by the vehicle, and accessing the data representative of a speed distribution profile relating to the identified manoeuvre.

5. The method of claim 1, further comprising providing the recommended speed to the driver of the vehicle.

6. The method of claim 1, wherein the insurance system is associated with a premium setting model or a risk assessment model.

7. The method of claim 1, wherein a safe speed is associated with a predetermined percentile range within the respective speed profile distribution.

8. The method of claim 7, further comprising assigning a penalty or bonus for use in the model based on the driving of the subscriber driver in relation to the predetermined percentile range.

9. The method of claim 8, wherein the penalty or bonus is sent to an insurance provider associated with the subscriber driver.

10. A computer-readable medium which stores a set of instructions which when executed performs a method of providing driver behaviour based insurance, the method executed by the set of instructions comprising:
accessing a digital map having data indicative of a plurality of navigable segments, wherein the digital map further comprises data representative of a speed distribution profile for one or more positions along at least one of the navigable segments, the speed distribution profile for a position being indicative of the speed of multiple drivers at the position;
using the data representative of a speed distribution profile to set a recommended speed for vehicles travelling along the at least one navigable segment; and
monitoring the speed of a subscriber driver when travelling along the at least one navigable segment to obtain data regarding the speed of the driver relative to the recommended speed for at least one of the one or more positions, and using the relative speed data as an input to a model of a user based insurance system.

11. The computer-readable medium of claim 10, wherein the method executed by the set of instructions further comprises providing the recommended speed to the driver of the vehicle.

12. The computer-readable medium of claim 10, wherein the insurance system is associated with a premium setting model or a risk assessment model.

13. The computer-readable medium of claim 10, wherein a safe speed is associated with a predetermined percentile range within the respective speed profile distribution.

14. The computer-readable medium of claim 13, wherein the method executed by the set of instructions further comprises assigning a penalty or bonus for use in the model based on the driving of the subscriber driver in relation to the predetermined percentile range.

15. The computer-readable medium of claim 14, wherein the method executed by the set of instructions further comprises sending the penalty or bonus is sent to an insurance provider associated with the subscriber driver.

16. A system for providing driver behaviour based insurance comprising:
at least one memory storage; and
at least one processing unit coupled to the at least one memory storage, wherein the at least one processing unit is operative to:
accessing a digital map having data indicative of a plurality of navigable segments, wherein the digital map further comprises data representative of a speed distribution profile for one or more positions along at least one of the navigable segments, the speed distribution profile for a position being indicative of the speed of multiple drivers at the position;
using the data representative of a speed distribution profile to set a recommended speed for vehicles travelling along the at least one navigable segment; and
monitoring the speed of a subscriber driver when travelling along the at least one navigable segment to obtain data regarding the speed of the driver relative to the recommended speed for at least one of the one or more positions, and using the relative speed data as an input to a model of a user based insurance system.

17. The system of claim 16, further comprising a database containing data representing a digital map having data indicative of a plurality of navigable segments, wherein the digital map further comprises data representative of a speed distribution profile for one or more positions along at least one of the navigable segments, the speed distribution profile for a position being indicative of the speed of multiple drivers at the position.

18. The system of claim 16, wherein a safe speed is associated with a predetermined percentile range within the respective speed profile distribution.

19. The system of claim 18, wherein the at least one processing unit is further operative to assign a penalty or bonus for use in the model based on the driving of the subscriber driver in relation to the predetermined percentile range.

20. The system of claim 19, wherein the at least one processing unit is further operative to send the penalty or bonus is sent to an insurance provider associated with the subscriber driver.
